(19) United States
(12) Patent Application Publication
(10) Pub. No.: US 2010/0271312 A1
(43) Pub. Date: Oct. 28, 2010

(54) Menu Configuration System and Method for Display on an Electronic Device

(76) Inventors: Rachid Alameh, Crystal Lake, IL (US); Roger Ady, Chicago, IL (US); Dale Bengtson, Crystal Lake, IL (US); Ricky J. Hoobler, Lake Bluff, IL (US); Jin Kim, Pleasant Prairie, WI (US); Jeffrey Olson, San Francisco, CA (US); Hoi Young, Lake Villa, IL (US)

Correspondence Address: PHILIP H. BURRUS, IV, 460 Grant Street, Atlanta, GA, 30312, US

(21) Appl. No.: 12/428,187

(22) Filed: Apr. 22, 2009

(51) Int. Cl. G06F 3/041

(52) U.S. Cl. 345/173

(57) ABSTRACT

A method (100) and electronic device (700) for presenting user actuation targets (1101,1102,1103) on a touch sensitive display (701) includes a controller (805) configured to determine a user actuation target arrangement (1500) having a hierarchy of precedence (1501). A display driver (809) is then configured to present the user actuation targets (1101,1102,1103) on the touch sensitive display (701) in accordance with the user actuation target arrangement (1500). This can include presenting user actuation targets (1201,1202) having a higher precedence closer to a user's finger (1206) than user actuation targets (1203,1204) having a lower precedence, or by magnifying user actuation targets (1201,1202) having a higher precedence. Precedence can be determined by most frequently selected targets, most recently selected targets, or other factors.

### CROSS REFERENCE TO RELATED APPLICATIONS

This application is related to U.S. Ser. No. ______, entitled “Touch-Screen and Method for an Electronic Device,” filed , attorney docket No. BPCUR0096RA (CS36437), which is incorporated herein by reference.

### BACKGROUND

1. Technical Field

This invention relates generally to touch sensitive user interfaces for electronic devices, and more particularly to a system and method for presenting user actuation targets on a display.

2. Background Art

Portable electronic devices, including mobile telephones, music and multimedia players, gaming devices, personal digital assistants, and the like are becoming increasingly commonplace. People use these devices to stay connected with others, to organize their lives, and to entertain themselves. Advances in technology have made these devices easier to use. For example, while these devices used to have a dedicated display for presenting information and a keypad for receiving input from a user, the advent of “touch-sensitive screens” have combined the display and keypad. Rather than typing on a keypad, a user simply touches the display to enter data. Touch-sensitive displays, in addition to being dynamically configurable, allow for more streamlined devices that are sometimes preferred by consumers.

One problem associated with traditional touch sensitive displays is that the information presented on the display is often configured as it would be on a personal computer. For example, some portable electronic devices have operating systems that mimic computer operating systems in presentation, with some controls in the corner, others, along the edge, and so forth. When a user wishes to activate a program or view a file, the user may have to navigate through several sub-menus. Further, the user may have to move their fingers all around the display to find and actuate small icons or menus. Not only it such a presentation conducive to the user mistakenly touching the wrong icons, it is especially challenging when the user is operating the device with one hand.

There is thus a need for an improved electronic device that has a touch-sensitive screen and information presentation that resolves these issues.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one embodiment of a method for presenting user actuation targets on a touch sensitive display in accordance with embodiments of the invention.

FIG. 2 illustrates one embodiment of sub-steps of a method for presenting user actuation targets on a touch sensitive display in accordance with embodiments of the invention.

FIG. 3 illustrates one embodiment of sub-steps a method for presenting user actuation targets on a touch sensitive display in accordance with embodiments of the invention.

FIG. 4 illustrates one embodiment of a method for presenting user actuation targets on a touch sensitive display in accordance with embodiments of the invention.

FIG. 5 illustrates one embodiment of sub-steps a method for presenting user actuation targets on a touch sensitive display in accordance with embodiments of the invention.

FIG. 6 illustrates one embodiment of a method for presenting user actuation targets on a touch sensitive display in accordance with embodiments of the invention.

FIG. 7 illustrates one embodiment of an electronic device having a touch sensitive display in accordance with embodiments of the invention.

FIG. 8 illustrates one embodiment of a schematic block diagram for an electronic device having a touch sensitive display in accordance with embodiments of the invention.

FIG. 9 illustrates one configuration of placement locations for user actuation target presentation in accordance with embodiments of the invention.

FIG. 10 illustrates one configuration of placement locations for user actuation target presentation in accordance with embodiments of the invention.

FIG. 11 illustrates user actuation target presentation in accordance with one embodiment of the invention.

FIG. 12 illustrates user actuation target presentation in accordance with one embodiment of the invention.

FIG. 13 illustrates a depiction of a user actuation target arrangement in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to presenting menus and user actuation targets on the touch sensitive display of an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors, computer readable media, and unique stored program instructions that control the one or more processors to implement, in conjunction with certain non-processor circuits, some, most, or all of the functions of menu and user actuation target presentation on a touch-sensitive display as described herein. As such, these functions may be interpreted as steps of a method to perform the determination of the placement or presentation of menus and user actuation targets on the touch-sensitive display, as well as the presentation of menus, information, and user actuation targets so as to correspond with the placement or motion of the user's finger or stylus. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide methods and apparatuses for presenting user-friendly menus and user actuation targets on a touch-sensitive display. In one embodiment, an electronic device determines the placement of a user's finger or stylus on the display and presents a menu of options about that location. The menu can be presented in a curved configuration about the location, so that each option is equally easy to reach.

In one embodiment, the system presents preferred user actuation targets closer to the location than less-preferred user actuation targets. For example, more recently selected user actuation targets may be placed closer to the user's finger or stylus than less recently selected user actuation targets. In another embodiment, more frequently selected user actuation targets may be placed closer to the user's finger or stylus than less frequently selected user actuation targets.

Similarly, in another embodiment, context driven icons, such as those used with a particular application that is running on the device may be placed closer to the user's finger or stylus than global icons, which may be used with a variety of programs. These global icons would be presented farther from the user's finger or stylus.

In another embodiment, a controller creates a user actuation history by tracking which icons are actuated at which times, how frequently, in which environments, and so forth. The controller can then use this user actuation history to determine a hierarchy of precedence with the various icons or user actuation targets that may be presented. In one embodiment, user actuation targets having a greater precedence can be presented closer to the user's finger or stylus, while those with a lesser precedence can be presented farther from the user's finger or stylus. In another embodiment, user actuation targets having a greater precedence can be magnified to appear larger than those having a lesser precedence.

Examples of precedence hierarchies include user history hierarchies, environmental hierarchies, or operational mode hierarchies. In user history hierarchies, the controller may determine precedence based upon what user actuation targets a particular user tends to actuate at certain times, certain locations, or in certain situations. Those higher precedence user actuation targets can be presented closer to the user's finger or stylus. Alternatively, these higher precedence user actuation targets can be presented in a magnified form.

In environmental hierarchies, the controller may receive information from outside sources, such as weather information services, traffic information services, and so forth. The controller can correlate received information to create an environmental hierarchy of precedence.

For instance, when it is raining, the controller may present weather related user actuation targets closer to a user's finger or stylus than non-weather related user actuation targets. Alternatively, these higher precedence user actuation targets can be presented in a magnified form. Similarly, if the controller is receiving location information, such as from a Global Positioning System (GPS) source, and the controller determines that the device is near the sea, the controller may present aquatic user actuation targets - such as marine supply stores or ultraviolet radiation information—closer to the user's finger or stylus than would be in-land user actuation targets. Alternatively, these higher precedence user actuation targets can be presented in a magnified form.

In operational hierarchies, the controller may use electronic sensors within the device to determine the operating state of the electronic device and may create precedence hierarchies from this information. By way of example, if the controller determines that the device's internal battery has a low amount of energy stored therein, in a telephone mode the controller may present an emergency call or emergency contact user actuation target closer to the user's finger or stylus than less used contact actuation targets. Alternatively, these higher precedence user actuation targets can be presented in a magnified form.

In another embodiment, in addition to repositioning user actuation targets within a particular display or menu, submenus triggered by primary menu selections may be presented in a user-friendly format as well. Where the electronic device includes both circuit for determining the location of a user's finger or stylus and the pressure being applied by the finger or stylus, this pressure detection can be used to trigger sub-menus. For example, when the pressure is in a first range, a first menu can be presented. When the pressure is in a second range, a second menu can be presented.

This multiple presentation of menus can be used in several ways. In one embodiment, the second menu is a sub-menu of the first menu. There will be situations, however, where it is difficult to show all the user actuation targets associated with a particular menu on the display with a desired font size. In one embodiment, the second menu can include the user actuation targets of the first menu in addition to other user actuation targets. In such an embodiment, by increasing the pressure from within the first range to within the second range, additional user actuation targets can be shown while decreasing the font size of each user actuation target. For example, if the finger touches the touch screen with low pressure, only the top menu (of most used icons) may be presented to the user. By pressing harder, the user can access the submenu by switching to the submenu presentation or squeezing the submenu content with the main menu content. In another embodiment, submenus can be presented with different color systems to distinguish its menu hierarchy level relative to the whole menu hierarchy.

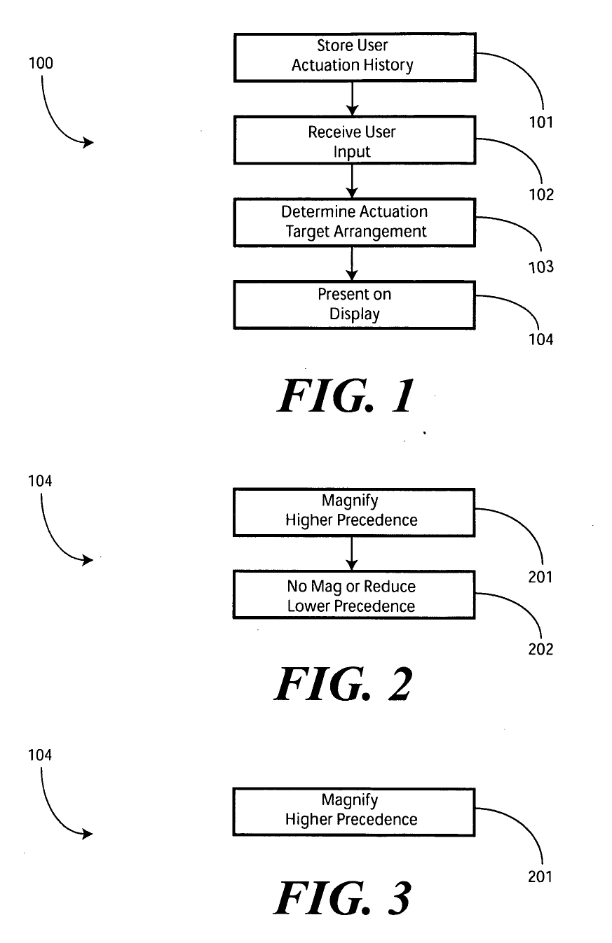

Turning now to FIG. 1, illustrated therein is one method 100 for presenting menus or user actuation targets to a user on a touch-sensitive display in accordance with embodiments of the invention. The method 100 of FIG. 1 is suitable for coding into executable instructions that can be stored within a computer-readable medium, such as a memory, such that the instructions can be executed by one or more processors to execute the method within an electronic device.

At step 101, a controller within the device monitors for some time which user actuation targets are actuated, and in which situations these user actuation targets or menus are actuated. This information regarding at least some of the user actuation target selections made by the user can be stored in a corresponding memory as a user actuation history. The controller may store, for example, the times at which user actuation targets are selected, the frequency of which user actuation targets are selected, applications that are operational on the device when user actuation targets are selected, environmental conditions during which user actuation targets are selected, device operating characteristics with which user actuation targets are selected, or combinations of these characteristics. Embodiments of the present invention are not limited to these characteristics, as other characteristics will be obvious to those of ordinary skill in the art having the benefit of this disclosure.

In one embodiment, the user actuation history will include a hierarchy of precedence. Various hierarchies have been discussed above, and will not be repeated here for brevity. However, some examples of hierarchies include frequency of use, recentness of use, and so forth. Designers employing embodiments of the invention may tailor the hierarchies to be device, application, or otherwise specific.

In one embodiment, the user actuation history comprises a user selection time that corresponds to the user actuation selections stored therein. For example, the controller may determine the time of day that each user actuation target is selected and may correspondingly time stamp the entries of the user actuation history.

At step 102, a user provides input to the electronic device by touching the touch sensitive screen. The controller receives this input, which calls for the presentation of a menu. As used herein, the term “menu” or “control menu” refers to the presentation of a plurality of user actuation targets. In one embodiment, the user actuation targets are related, such as those used to edit a file or send an e-mail. In another embodiment, the user actuation targets are not related. In one embodiment, the menu can be presented in a conventional tabular form. In another embodiment, the menu can be presented in a horizontal tabular form. In yet another embodiment, the menu can be presented in a curved form, such as about the location of a user's finger or stylus. In one embodiment the user actuation targets may be surrounded by a common menu border, while in another embodiment they may be presented as freestanding icons.

In one embodiment, the controller at this step 102 further determines a user actuation time corresponding to the user input request. For example, the controller may detect that a certain menu is requested during a certain time of day. This information can be used in certain embodiments with the next step described below.

At step 103, the controller determines a user actuation target arrangement from the user actuation target history. The user actuation target arrangement, in one embodiment, includes a hierarchy of precedence. The hierarchy of precedence can come from the user actuation history. Alternatively, the controller may determine its own hierarchy of precedence in response to the user input. For example, if a user actuates a weather information retrieval icon, and the weather is rain (as determined from a weather information service), the controller may create a hierarchy of precedence by placing satellite weather photo user actuation targets closer to the user's finger than temperature user actuation targets, as the user may be more interested in seeing pictures of cloud cover when inquiring about the weather during rain. Conversely, if the weather is sunny, a temperature user actuation target may be placed closer to the user's finger, as people are sometimes not interested in radar images when the weather is sunny.

In one embodiment, the controller at this step 103 determines the user actuation target arrangement from the user selection time corresponding to the input received at step 102 and from the user selection times stored in the user actuation history at step 101. From this information, the controller is able to determine a user actuation target arrangement that corresponds to a particular user's history of device operation. For example, where a user actuates an icon to order lunch each day between noon and one in the afternoon, the controller may construct a user actuation target arrangement with restaurant related icons having a higher precedence than non-restaurant related icons.

At step 104, the controller or a display driver presents at least a portion of the user actuation targets on the display. In one embodiment, the user actuation targets are ordered in accordance with the user actuation target arrangement. Note that the term “order” as used herein can mean a progressive order, such as top to bottom or right to left. Alternatively, it can refer to a distance from a predetermined location, such as a distance from a user's finger. Additionally, it can refer to a size, shape, or color of the user actuation targets. For example, user actuation targets of higher precedence can be presented with magnification, or in a different color, than those with a lower precedence.

In one embodiment, where the controller is configured to determine a user actuation time at step 102 and is further configured to determine the user actuation target arrangement from corresponding user actuation times of the user actuation history at step 103, this step 104 includes presenting the user actuation targets on the display such that user actuation targets having user selection times closer to the user actuation time are closer to the user's finger or stylus than user actuation targets having user selection times farther from the user actuation time. In another embodiment, this step 104 includes presenting the user actuation targets on the display such that user actuation targets having user selection times closer to the user actuation time are magnified or larger than user actuation targets having user selection times farther from the user actuation time.

Turning briefly to FIG. 2, illustrated therein is one embodiment of step 104 from FIG. 1, which illustrates an example of presenting user actuation targets ordered in accordance with the user actuation target hierarchy. Specifically, in this illustrative embodiment, at step 201, the controller or display driver magnifies some user actuation targets such that at least one user actuation target having a higher precedence appears bigger than at least another user actuation target having a lower precedence. At step 202, at least one user actuation target having a lesser precedence can optionally be reduced or retained at a normal size, so as to be smaller than the magnified user actuation target having a higher precedence.

Turning now to FIG. 3, illustrated therein is an optional step 301 that can be included in one embodiment of step 104 from FIG. 1. Specifically, in optional step 301, the user actuation targets are presented in a curved configuration on the display. This configuration can be circular, oval, semi-circular, or another curved configuration. In one embodiment, this optional step 301 includes presenting the user actuation targets in a spiral or flower-petal type configuration that is concentric or otherwise about the user actuation target selected at step 102 of FIG. 1. Such a menu configuration is frequently more efficient for the user in that this placement of user actuation targets requires shorter travel to the desired user actuation target.

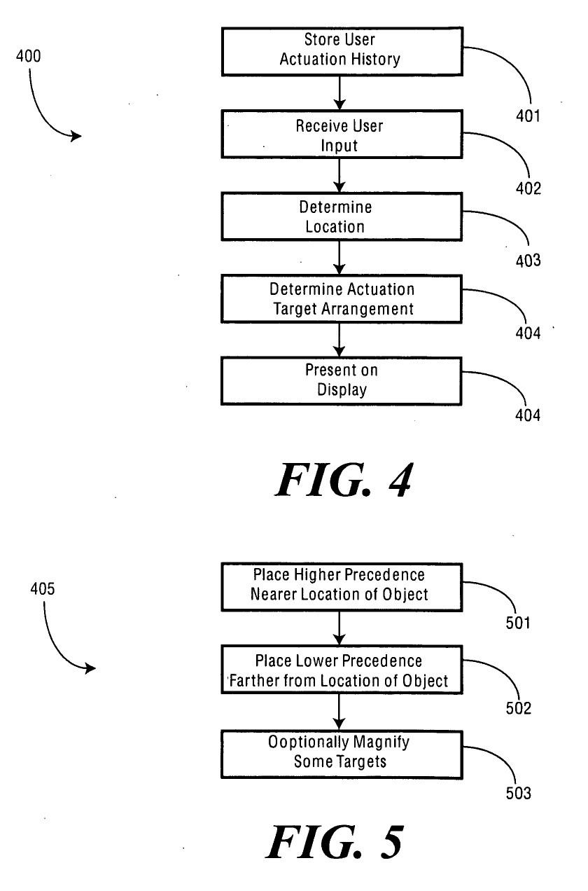

Turning now to FIG. 4, illustrated therein is one method 400 for presenting menus or user actuation targets to a user on a touch-sensitive display in accordance with embodiments of the invention that employs not only a menu selection, but also a determination of the user's finger or stylus when making that determination. At step 401, as with step 101 of FIG. 1, a controller within the electronic device monitors—for some period of time—which user actuation targets are actuated. Optionally, the controller can monitor in which situations or with which applications these user actuation targets or menus are actuated as well. This information regarding at least some of the user actuation target selections made by the user can be stored in a corresponding memory as a user actuation history.

In one embodiment, the user actuation history will include a hierarchy of precedence. Various hierarchies have been discussed above, and some examples include frequency of use, recentness of use, and so forth. Designers employing embodiments of the invention may tailor the hierarchies to be device, application, or otherwise specific.

At step 402, a user provides input to the electronic device by touching the touch sensitive screen. The user may touch a user actuation target, icon, or menu, thereby requesting additional information be presented on the touch sensitive display. The controller receives this input.

At step 403, the controller determines a location of an object proximately located with the touch sensitive display that is responsible for, or otherwise corresponds to, the user input received at step 402. For example, if the user touches an icon with a finger, the controller can detect the location of the finger at step 403. Similarly, if the user touches an icon with a stylus, the controller can determine the location of the stylus at step 403. As will be described below, determining the location of the object can be accomplished in a variety of ways, including triangulation of three or more infrared sensors or by way of a capacitive layer capable of determining location of contact. Further, other location determining systems and methods will be obvious to those of ordinary skill in the art having the benefit of this disclosure.

At step 404, the controller determines a user actuation target arrangement from the user actuation target history. The user actuation target arrangement, in one embodiment, includes a hierarchy of precedence. The hierarchy of precedence can come from the user actuation history. Alternatively, the controller may determine its own hierarchy of precedence in response to the user input.

At step 405, the controller or a display driver presents at least a portion of the user actuation targets on the display. In one embodiment, the user actuation targets are ordered in accordance with the user actuation target arrangement. Further, in the illustrative embodiment of FIG. 4, the step 405 of presenting the user actuation targets includes presenting the user actuation targets such that user actuation targets having a higher precedence are presented closer to the location of the object, as determined in step 403, than are user actuation targets having a lower precedence. This embodiment of step 405 is shown in detail in FIG. 5.

Turning now to FIG. 5, which illustrates one embodiment of step 405 from FIG. 4, at step 501 user actuation targets having a higher precedence are presented closer to the location. At step 502, user actuation targets having a lower precedence are presented farther from the location. For example, where the location determined is the location that a user's finger touches the touch sensitive display, user actuation targets having a higher precedence may be presented closer to the user's finger than those having a lower precedence. At optional step 503, magnification is employed. In this step 503, user actuation targets having a higher precedence are presented such that they are larger in presentation than are other user actuation targets having lower precedence.

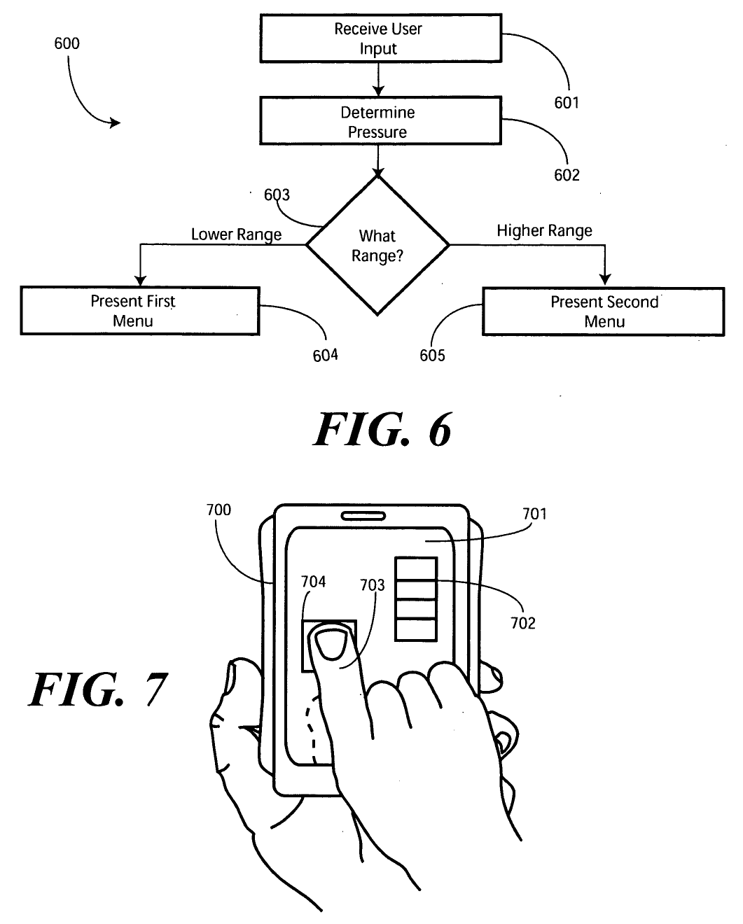

Turning now to FIG. 6, illustrated therein is one method 600 for presenting menus or user actuation targets to a user on a touch-sensitive display in accordance with embodiments of the invention that employs not only a menu selection, but also a determination of the pressure applied by a user's finger or stylus when making that determination. At step 601, a user provides input to the electronic device by touching the touch sensitive screen. The user may touch a user actuation target, icon, or menu, thereby requesting additional information be presented on the touch sensitive display. The controller receives this input.

At step 602, the controller, by way of a pressure sensor, determines an amount of pressure being exerted upon the touch sensitive display by the user at step 601. As will be explained below, this can be accomplished in a variety of ways. One way is via a force-sensing resistor. Another way is via a compliance member.

Once the amount of pressure is known, this information can be used in the presentation of user actuation targets or menus. For example, at decision 603, the controller determines whether the pressure being applied is within a first range or a second range. In one embodiment, the first range is less than the second range. The first range may run from zero to one Newton, while the second range may be any force in excess of one Newton. It will be clear to those of ordinary skill in the art having the benefit of this disclosure that these ranges are illustrative only. Further, embodiments of the invention are not limited to two ranges - three or more ranges may also be used for greater resolution in actuation target presentation.

Once this decision 603 is made, the controller or a display driver may present a first menu at step 604 when the amount of pressure is within the first range. The controller or display driver may present a second menu at step 605 when the amount of pressure is within the second range. As noted above, the first menu and second menu can be related in a variety of ways. In one embodiment, the second menu can include the user actuation targets of the first menu in addition to other user actuation targets. In such an embodiment, by increasing the pressure from within the first range to within the second range, additional user actuation targets can be shown while decreasing the font size of each user actuation target. For example, if the finger touches the touch screen with low pressure, only the top menu (of most used icons) may be presented to the user. By pressing harder, the user can access the submenu by switching to the submenu presentation or squeezing the submenu content with the main menu content. In another embodiment, submenus can be presented with different color systems to distinguish its menu hierarchy level relative to the whole menu hierarchy.

In one embodiment, the second menu is a subset of the first menu. In another embodiment, the second menu can be the first menu magnified, with or without the addition of other user actuation targets. Said differently, the second menu can comprise the first menu. It may alternatively comprise a sub-portion of the first menu. Elements of the second menu can be magnified relative to the first menu as well. One or both of the first menu or second menu can be presented in a curved configuration about the user input detected at step 601. Further, elements of the first menu and second menu can be color-coded in different configurations. For example, the first menu may be presented in a first color while the second menu is presented in a second color. The first color and second color can be the same. Alternatively, they can be different.

Now that the methods have been illustrated and described, various apparatuses and devices employing embodiments of the invention will be shown. Turning to FIG. 7, illustrated therein is one embodiment of an electronic device 700 suitable for executing methods and for presenting menus and user actuation targets in accordance with embodiments of the invention.

The electronic device 700 includes a touch sensitive display 701 for presenting information 702 to a user. The touch sensitive display 701 is configured to receive touch input 703 from a user. For instance, the user may touch a user actuation target 704 to request a menu or other user actuation targets associated with applications of the electronic device 700. The information 702 presented on the touch sensitive display 701 can include menus and other user actuation targets requested by the user.

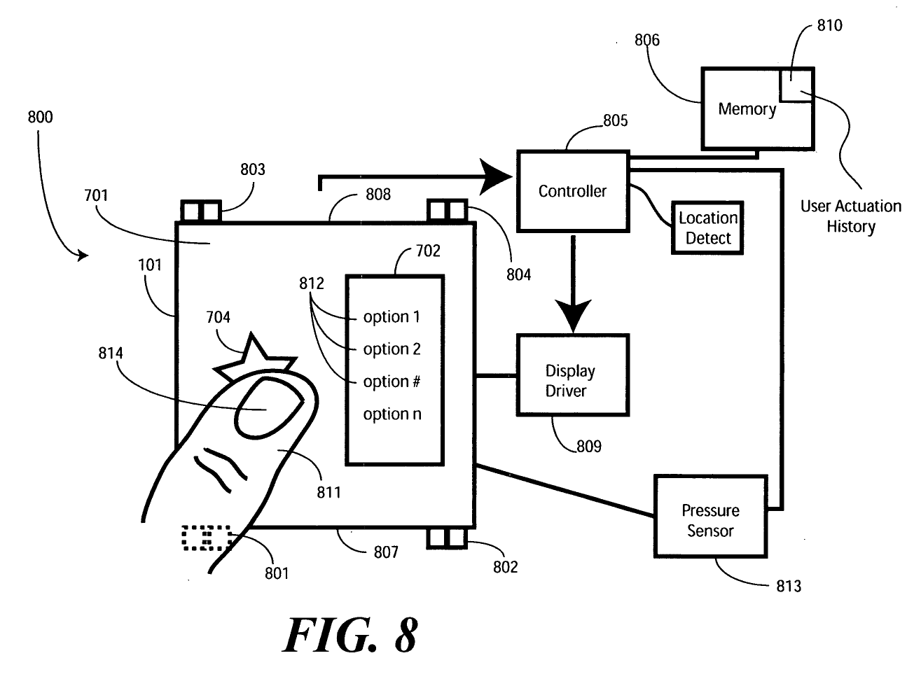

Turning now to FIG. 8, illustrated therein is a schematic block diagram 800 of the inner circuitry of the electronic device 700 of FIG. 7. Note that the schematic block diagram 800 of FIG. 8 is illustrative only, as devices and sensors other than those shown will be capable of presenting information (702) to a user in accordance with embodiments of the invention.

A touch sensitive display 701 is configured to present information 702 to a user. In the illustrative embodiment of FIG. 7, the touch sensitive display 701 includes an infrared detector employing three or more infrared transceivers 801,802,803,804 for determining touch. Embodiments of the invention are not so limited, however. It will be obvious to those of ordinary skill in the art having the benefit of this disclosure that other touch-sensitive displays can be used as well. For example, commonly assigned U.S. patent application Ser. No. 11/679,228, entitled “Adaptable User Interface and Mechanism for a Portable Electronic Device,” filed Feb. 27, 2007, which is incorporated herein by reference, describes a touch sensitive display employing a capacitive sensor. Such a capacitive sensor can be used rather than the infrared detector described in the illustrative embodiment of FIG. 8.

The illustrative touch sensitive display 701 of FIG. 8 includes at least four infrared transceivers 801,802,803,804 that are disposed about the touch sensitive display 701. While at least four transceivers will be used herein as an illustrative embodiment, it will be clear to those of ordinary skill in the art having the benefit of this disclosure that the invention is not so limited. Additional transceivers may be disposed about the touch sensitive display 701 as needed by a particular application. Additionally, while a square or rectangular touch sensitive display 701 is shown herein for discussion purposes, the invention is not so limited. The touch sensitive display 701 could have any number of sides, could be round, or could be a non-uniform shape as well.

A controller 805 is operable with the infrared transceivers 801,802,803,804. The controller 805, which may be a microprocessor, programmable logic, application specific integrated circuit device, or other similar device, is capable of executing program instructions—such as those shown in FIGS. 1-6—which may be stored either in the controller 805 or in a memory 806 or other computer readable medium coupled to the controller 805.

In one embodiment, the controller 805 is configured to detect which of the four infrared transceivers 801,802,803,804 receives a most reflected light signal. As the light emitting elements of each infrared transceiver 801,802,803,804 emit infrared light, that infrared light is reflected off objects such as fingers and stylus devices that are proximately located with the surface of the touch sensitive display 701. Where each light-receiving element of the infrared transceivers 801,802,803,804 receives light having approximately the same signal strength, the controller 805 is configured to correlate this with the object being located relatively within the center of the touch sensitive display 701. Where, however, one infrared transceiver 801,802,803,804 receives a highest received signal, or, in an alternate embodiment a received signal above a predetermined threshold, the controller 805 is configured to correlate this with a finger or other object being located near or atop that particular infrared transceiver.

Where the controller 805 determines that a finger or other object is near or atop a particular infrared transceiver, that information can be used to correlate the object's location with a particular mode of operation. For example, in the illustrative embodiment of FIG. 8, the touch sensitive display 701 has two infrared transceivers 801,802 disposed along the bottom 807 of the touch sensitive display 701, while two infrared transceivers 803,804 are disposed along the top 808 of the touch sensitive display 701. Where the electronic device (700) is being held upright by the user, and an infrared transceiver 801,802 disposed along the bottom 807 of the touch sensitive display 701 is receiving the most reflected signal, it can mean that user is operating the touch sensitive display 701 with their thumbs. Where the infrared transceiver 801,802 receiving the most reflected signal is the infrared transceiver 801 on the lower, left corner of the touch sensitive display 701, this can indicate a user operating the touch sensitive display 701 with one hand, and more particularly the left hand. Where the infrared transceiver 801,802 receiving the most reflected signal is the infrared transceiver 802 on the lower, right corner of the touch sensitive display 701, this can indicate a user operating the touch sensitive display 701 with one hand, and more particularly the right hand.

In one embodiment of the invention, the controller 805 is configured to determine not only that an object is in contact with the touch sensitive display 701, but, as noted above, the location of the object along the touch sensitive display 701. This is accomplished, in one embodiment, by triangulation between the various infrared transceivers 801,802,803,804. Triangulation to determine an object's location by reflecting transmitted waves off the object is well known in the art. Essentially, in triangulation, the infrared transceivers are able to determine the location of a user's finger, stylus, or other object by measuring angles to that object from known points across the display along a fixed baseline. The user's finger, stylus, or other object can then be used as the third point of a triangle with the other vertices known.

Where a finger or object is atop a particular infrared transceiver, as indicated by a transceiver having a most received signal or a signal above a predetermined threshold, this transceiver is generally not suitable for triangulation purposes. As such, in accordance with embodiments of the invention, upon determining an infrared transceiver receiving a most reflected light signal, the controller 805 can be configured to determine the objects location by triangulation using only infrared transceivers other than the one receiving the most reflected signal. In the illustrative embodiment of FIG. 8, wherein infrared transceiver 801 is receiving the most reflected signal, the controller 805 can be configured to determine the corresponding object's location by triangulation using infrared transceivers 802,803,804.

A display driver 809 is operable with the controller 805 and is configured to present the information 703 on the touch sensitive display 701. The controller 805, in one embodiment, is configured to receive user input from the touch sensitive display and to construct a user actuation history 810, which may be stored in the memory 806. In one embodiment, the controller 805 is configured to store user actuation target selections in the user actuation history 810. In addition, the controller may store other information, such as time, environment, device operational status, and so forth, as previously described, in the user actuation history 810.

In response to the user 811 actuating the touch sensitive display 701, such as by touching a user actuation target 704, the controller 805 is configured to determine a user actuation precedence hierarchy from the user actuation history 810 in accordance with the methods described above. For example, in one embodiment the user actuation target history comprises a ranking of more recently selected user actuation targets. In another embodiment, the user actuation target history comprises a ranking of most frequently selected user actuation targets. The display driver 809 is then configured to present a plurality of user actuation targets 812 on the display in accordance with the user actuation target precedence hierarchy as described above.

By way of example, in one embodiment the display driver 809 is configured to present some user actuation targets with magnification such that at least one user actuation target having a higher precedence is larger in presentation on the touch sensitive display 701 than at least another user actuation target having a lower precedence. In another embodiment, when the controller 805 determines the location of the user's finger, such as by triangulation of the infrared transceivers 801,802,803,804, the display driver is configured to present at least some user actuation targets having higher precedence closer to the location of the user's finger than at least some other user actuation targets having lower precedence. In one embodiment, the display driver 809 is configured to present the user actuation targets in a curved configuration about the determined location.

In one embodiment, the schematic block diagram 800 includes a pressure detector 813 for determining a force exerted by the user 811 upon the touch sensitive display 701. There are a variety of pressure detectors 813 available for this purpose. For example, commonly assigned U.S. patent application Ser. No. 11/679,228, entitled “Adaptable User Interface and Mechanism for a Portable Electronic Device,” filed Feb. 27, 2007, which is incorporated by reference above teaches the use of a force-sensing resistor. An alternate embodiment of a force sensor is described in commonly assigned, copending U.S. patent application Ser. No. 12/181,923, entitled “Single Sided Capacitive Force Sensor for Electronic Devices,” filed Jul. 29, 2008, which is incorporated herein by reference. Others will be known to those of ordinary skill in the art having the benefit of this disclosure.

Where a pressure detector 813 is employed, the pressure detector 813 is operatively coupled with the controller 805. The pressure detector 813 is configured to determine a user pressure 814 corresponding to the user's actuation of the touch sensitive display 701. The controller 805 can then determine whether this user pressure 814 is within a predetermined range, and the display driver 809 can present information 702 accordingly. For example, in one embodiment a predetermined set of pressure ranges can be used. In such an embodiment, when the user pressure 814 is in a first range, the display driver 809 is configured to present at least some user actuation targets. When the user pressure 814 is in a second range, the display driver 809 is configured to present at least some other user actuation targets. This will be shown in more detail in the following figures.

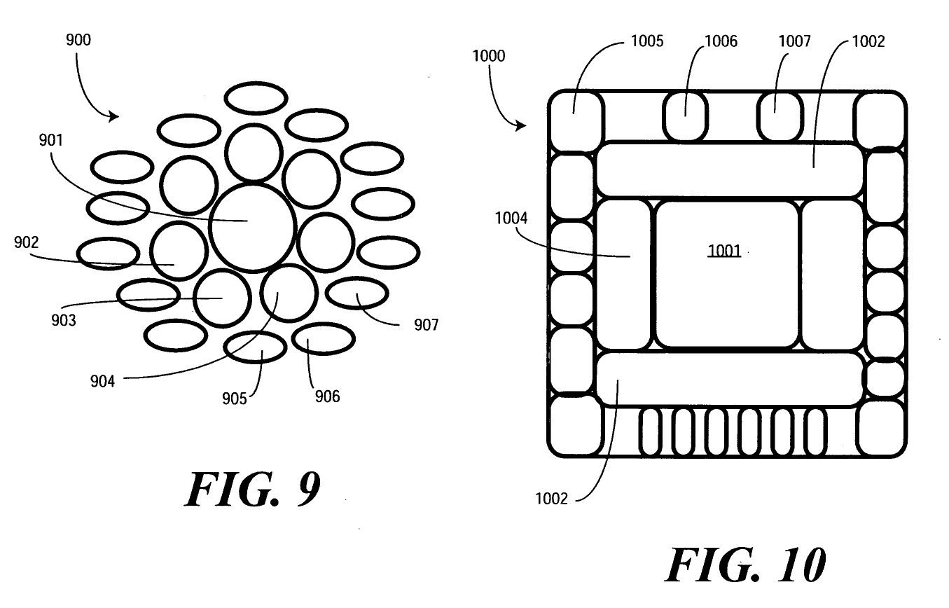

Turning now to FIG. 9, illustrated therein is one embodiment of a curved menu 900 that shows illustrative user actuation target placement locations that can be presented about the location 901 of a user's finger or stylus. By way of example, user actuation targets having higher precedence 902,903,904 can be presented closer to the location 901 of the user's finger or stylus than user actuation targets having a lower precedence 905,906,907. Each of these user actuation targets shown in FIG. 9 is presented in a curved configuration about the location 901 of the finger or stylus.

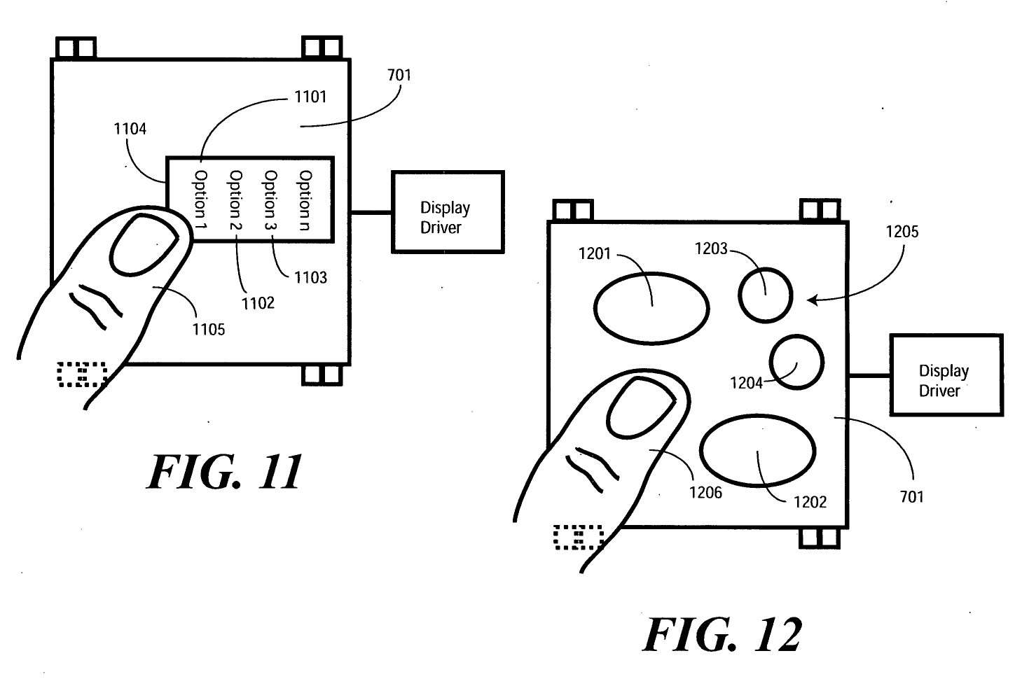

Turning now to FIG. 10, illustrated therein is a rectangular menu 1000 that shows illustrative user actuation target placement locations that can be presented about the location 1001 of a user's finger or stylus. By way of example, user actuation targets having higher precedence 1002,1003,1004 can be presented closer to the location 1001 of the user's finger or stylus than user actuation targets having a lower precedence 1005,1006,1007. Each of these user actuation targets shown in FIG. 10 is presented in an orthogonal configuration about the location 1001 of the finger or stylus. Note also that the illustrative embodiment of FIG. 10 shows the magnification discussed above. Specifically, user actuation targets having higher precedence 1002,1003,1004 are presented with a larger presentation than user actuation targets having a lower precedence 1005,1006,1007.

The menus 900, 1000 of FIGS. 9 and 10, respectively, can also be used when the pressure detector (813) is employed. For example, user actuation targets having a higher precedence 902,903,904 and 1002,1003,1004, respectively, can be presented when the user pressure (814) is within a first range, while user actuation targets having a lower precedence 905,906,907 and 1005,1006,1007, respectively, can be presented when the user pressure (814) is within a second range.

Turning now to FIG. 11, illustrated therein is an illustration of user actuation targets 1101,1102,1103 being presented on a touch sensitive display 701 in accordance with a user actuation target precedence hierarchy in accordance with embodiments of the invention. In FIG. 11, a menu 1104 including user actuation targets 1101,1102,1103 is presented in a horizontal, tabular configuration. As determined by the controller (805), user actuation target 1101 has a greater precedence than user actuation target 1102. User actuation target 1102 has a higher precedence than user actuation target 1103. Therefore, in this illustrative embodiment, user actuation target 1101 is presented closer to the user's finger 1105 than user actuation target 1102. Similarly, user actuation target 1103 is presented farther from the user's finger 1105 than user actuation target 1102. User actuation target 1101 may represent a more frequently selected user actuation target, a more frequently selected user actuation target, or it may meet another criterion giving it elevated precedence.

Turning now to FIG. 12, illustrated therein is another illustration of user actuation targets 1201,1202,1203,1204 being presented on a touch sensitive display 701 in accordance with a user actuation target precedence hierarchy in accordance with embodiments of the invention. In FIG. 12, the menu 1205, which including user actuation targets 1201,1202,1203,1204 is presented in a free-form configuration with the user actuation targets 1201,1202,1203,1204 being presented as round icons.

As determined by the controller (805), user actuation target 1201 has a greater precedence than user actuation target 1203, but par precedence with user actuation target 1202. User actuation target 1202 has a higher priority than user actuation target 1204. However, user actuation target 1204 has par precedence with user actuation target 1203. Therefore, in this illustrative embodiment, user actuation target 1201 is presented closer to the user's finger 1206 than user actuation target 1203. Similarly, user actuation target 1204 is presented farther from the user's finger 1206 than user actuation target 1202. At the same time, user actuation targets 1201,1202 are magnified, so as to appear larger than user actuation targets 1203,1204. Further, the user actuation targets 1201,1202,1203,1204 are presented in a curved configuration about the user's finger 1206.

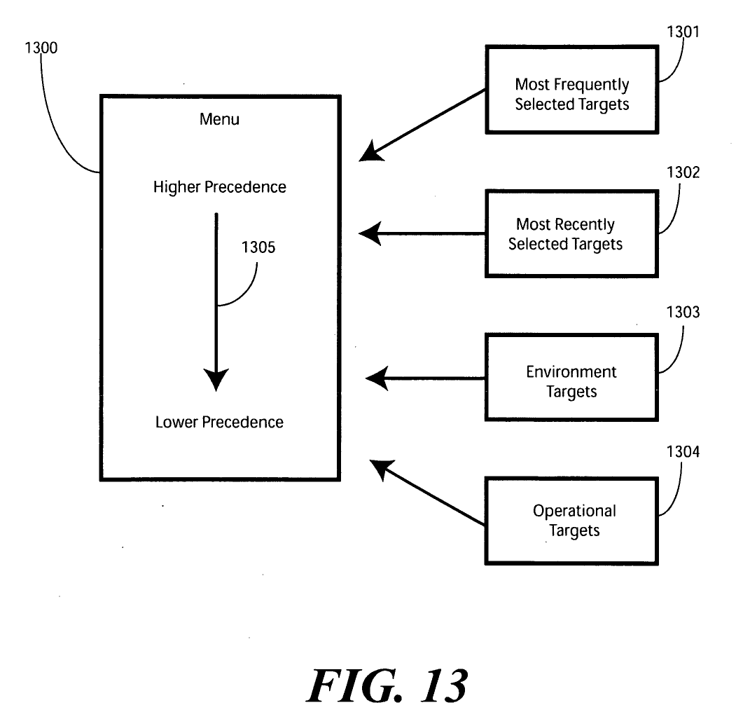

Turning now to FIG. 13, illustrated therein is a graphical representation of a user actuation target arrangement 1300 comprising a hierarchy of precedence 1301. Some of the factors that can be used to determine the hierarchy of precedence 1305 are also shown. As noted above, in various embodiments of the invention, the factors that can be considered include historical factors, environmental factors, or operational mode factors. In the illustrative embodiment depicted in FIG. 13, the factors include most frequently selected user actuation targets 1301, most recently selected user actuation targets 1302, environmental factors 1303, and operational state factors 1304.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A computer-readable medium in an electronic device, the electronic device comprising a processor and a display for presenting information to a user, the computer-readable medium including instructions for a method, when executed by the processor, to present one or more menus to the user on the display, the instructions comprising:
storing at least some user actuation target selections made by the user as a user actuation history;
receiving a user input request for a menu having a plurality of user actuation targets presented therein;
determining a user actuation target arrangement from the user actuation history, wherein the user actuation target arrangement comprises a hierarchy of precedence; and
presenting at least a portion of the plurality of user actuation targets on the display in the menu ordered in accordance with the user actuation target arrangement.

2. The computer-readable medium of claim 1, further comprising magnifying some user actuation targets such that at least one user actuation target having a higher precedence is larger in presentation on the display that at least another user actuation target having a lower precedence.

3. The computer-readable medium of claim 2, wherein the user actuation history comprises a user selection time corresponding to each of the at least some user actuation target selections, the instructions further comprising:
determining a user actuation time corresponding to the user input request;
determining the user actuation target arrangement from at least the user selection time corresponding to each of the at least some user actuation target selections; and
presenting at least the portion of the user actuation targets on the display such that user actuation targets having user selection times closer to the user actuation time are larger than user actuation targets having user selection times farther from the user actuation time.

4. The computer-readable medium of claim 1, the instructions further comprising:
determining a location of an object proximately located with the display corresponding to the user input request; and
presenting the at least the portion of the user actuation targets on the display such that user actuation targets having a higher precedence are presented closer to the object that user actuation targets having a lower precedence.

5. The computer-readable medium of claim 4, further comprising magnifying some of the at least the portion of the user actuation targets such that at least one user actuation target having the higher precedence is larger in presentation on the display that at least another user actuation target having the lower precedence

6. The computer-readable medium of claim 4, the instructions further comprising:
determining a user actuation time corresponding to the user input request;
determining the user actuation target arrangement from at least the user actuation time corresponding to each of the at least some user actuation target selections; and
presenting at least the portion of the user actuation targets on the display such that user actuation targets having user selection times closer to the user actuation time are presented nearer the object than user actuation targets having user selection times farther from the user actuation time.

7. The computer-readable medium of claim 1, the instructions further comprising:
determining a location of an object proximately located with the display corresponding to the user input request;
wherein the presenting at least the portion of the plurality of user actuation targets on the display comprises presenting the at least the portion of the user actuation targets in the menu, wherein the menu is curved about the object.

8. A computer-readable medium in an electronic device, the electronic device comprising a processor and a touch sensitive display for presenting information to a user, the computer-readable medium including instructions for a method, when executed by the processor, to present a menu to the user on the touch sensitive display, the instructions comprising:
determining an amount of pressure being exerted upon the touch sensitive display by the user; and
presenting the menu on the touch sensitive display in response to the amount of pressure being exerted on the touch sensitive display;
wherein when the amount of pressure is within a first pressure range the presenting comprises presenting a first menu on the touch sensitive display; and
wherein when the amount of pressure is within a second pressure range, the second pressure range comprising pressures greater than in the first pressure range, the presenting comprises presenting a second menu on the touch sensitive display.

9. The computer-readable medium of claim 8, wherein the second menu is a sub-menu of the first menu.

10. The computer-readable medium of claim 8, wherein the second menu is the first menu magnified.

11. The computer-readable medium of claim 8, wherein the second menu comprises the first menu.

12. The computer-readable medium of claim 11, wherein the second menu further comprises a sub-menu of the first menu.

13. The computer-readable medium of claim 8, wherein at least one of the first menu or the second menu is presented in a curved configuration.

14. The computer-readable medium of claim 8, wherein the first menu is presented in a first color and the second menu is presented in a second color, the second color being different from the first.

15. An electronic device, comprising:
a touch sensitive display for presenting information to a user;
a controller, operable with the touch sensitive display, and configured to receive user actuation input from the touch sensitive display;
a memory operatively coupled to the controller; and
a display driver, operable with the controller and configured to present a menu on the touch sensitive display;
wherein the controller is configured to construct a user actuation history by storing at least some display user actuation target selections in the memory, and in response to the user actuating the touch sensitive display, to determine a user actuation target precedence hierarchy from the user actuation history; and
wherein, in response to the user actuating the touch sensitive display, the display driver is configured to present a plurality of user actuation targets on the touch sensitive display in accordance with the user actuation target precedence hierarchy.

16. The electronic device of claim 15, wherein the display driver is configured to present some user actuation targets with magnification such that at least one user actuation target having a higher precedence is larger in presentation on the display that at least another user actuation target having a lower precedence.

17. The electronic device of claim 15, wherein the controller is further configured to determine a location along the touch sensitive display of an object proximately located with the electronic device, and wherein the display driver is further configured to present at least some user actuation targets having higher precedence closer to the location that at least some other user actuation targets having lower precedence.

18. The electronic device of claim 17, wherein the display driver is configured to present the at least some user actuation targets and the at least some other user actuation targets in a curved configuration about the location.

19. The electronic device of claim 15, further comprising a pressure sensor operatively coupled with the touch sensitive display and the controller, the pressure sensor being configured to determine a user pressure corresponding to the user actuation input, wherein when the user pressure is in a first range, the display driver is configured to present at least some user actuation targets, wherein when the user pressure is in a second range, the display driver is configured to present at least some other user actuation targets.

20. The electronic device of claim 15, wherein the user actuation target precedence hierarchy comprises one of most recently selected precedence and most frequently selected precedence.
